(19) United States
(12) Patent Application Publication
(10) Pub. No.: US 2020/0189323 A1
(43) Pub. Date: Jun. 18, 2020

(54) PNEUMATIC TIRE

(71) Applicant: TOYO TIRE CORPORATION, Itami-shi (JP)

(72) Inventor: Makoto Yoshikawa, Itami-shi (JP)

(73) Assignee: TOYO TIRE CORPORATION, Itami-shi (JP)

(21) Appl. No.: 16/710,288

(22) Filed: Dec. 11, 2019

(30) Foreign Application Priority Data
Dec. 14, 2018 (JP) 2018-234829

(51) Int. Cl. B60C 11/03; B60C 11/13

(52) U.S. Cl. CPC B60C 11/0306; B60C 11/11; B60C 11/13

(57) ABSTRACT

A pneumatic tire includes a shoulder main groove, shoulder lateral grooves extending from the shoulder main groove beyond a ground contact end in a direction inclined with respect to a tire width direction, and a shoulder block defined by them. The shoulder block is provided in its top face with a plurality of lateral edges that extend in the tire width direction, and that include an acute angle side lateral edge having an acute angle with respect to a tire circumferential direction, being formed with a chamfered portion. The chamfered portion occupies 50% or more of a region defined by a width of ¼ of a shoulder ground contact width W in the tire width direction, from the ground contact end to inward in the tire width direction.

### CROSS-REFERENCE TO RELATED APPLICATIONS

This application claims priority of Japanese Patent Application No. 2018-234829 filed on Dec. 14, 2018, the content of which is incorporated herein by reference.

### BACKGROUND OF THE INVENTION

### Technical Field

The present invention relates to a pneumatic tire.

### Related Art

There is known a pneumatic tire including: a plurality of main grooves extending in a tire circumferential direction provided in a tread portion, the main grooves including a shoulder main groove closest to a ground contact end in a tire width direction; shoulder lateral grooves extending from the shoulder main groove beyond the ground contact end in a direction inclined with respect to the tire width direction; and a shoulder block defined by the shoulder main groove and the shoulder lateral grooves (e.g., refer to JP 5702398 B2).

### SUMMARY

The shoulder lateral grooves are inclined with respect to the tire width direction, so that one of edges extending in the tire width direction on a top face of the shoulder block has an acute angle with respect to the tire circumferential direction. In this case, the shoulder block is likely to decrease in rigidity at the acute angle portion. In addition, ground contact pressure is likely to increase at or near the ground contact end in the tire width direction. Accordingly, the acute angle portion positioned at or near the ground contact end is likely to be relatively low in rigidity and high in ground contact pressure, and thus deforms more than a residual portion to slip more when coming into contact with a road surface, so that wear is likely to be accelerated.

In contrast, an obtuse angle portion facing the acute angle portion in the tire circumferential direction with each of the shoulder lateral grooves interposed between the obtuse angle portion and the acute angle portion is less likely to decrease in rigidity to have a less amount of wear. As a result, the acute angle portion where wear is likely to progress and the obtuse angle portion having a less amount of wear face each other in the tire circumferential direction with each of the shoulder lateral grooves interposed between the acute angle portion and the obtuse angle portion, and thus this tends to cause a problem of so-called toe and heel wear in which a difference in the amount of wear between them increases.

It is an object of the present invention to provide a pneumatic tire that can provide suppressed toe and heel wear at or near a ground contact end in a shoulder block defined by shoulder lateral grooves inclined with respect to a tire width direction.

The present invention provides a pneumatic tire including: a plurality of main grooves provided in a tread portion while extending in a tire circumferential direction, including a shoulder main groove closest to a ground contact end in a tire width direction; shoulder lateral grooves extending at least from the shoulder main groove beyond the ground contact end in a direction inclined with respect to a tire width direction; and a shoulder block defined by the shoulder main groove and the shoulder lateral grooves, the shoulder block having a top face provided with a plurality of lateral edges extending in the tire width direction, the plurality of lateral edges including an acute angle side lateral edge with an acute angle with respect to the tire circumferential direction, the acute angle side lateral edge being formed with a chamfered portion throughout a predetermined range in the tire width direction, and the chamfered portion occupying 50% or more of a region from the ground contact end inward in the tire width direction, the region being defined by a width of ¼ of a shoulder ground contact width from the shoulder main groove to the ground contact end in the tire width direction.

According to the present invention, the chamfered portion is formed at or near the ground contact end where the ground contact pressure is particularly likely to increase in the acute angle side lateral edge of the shoulder block. Forming the chamfered portion causes the portion at or near the ground contact end in the acute angle side lateral edge, having relatively low rigidity, to be less likely to come into contact with the ground. As a result, wear in the portion at or near the ground contact end in the acute angle side lateral edge is suppressed to cause reduction in a difference in the amount of wear between the acute angle side lateral edge and an obtuse angle side lateral edge in the shoulder block, adjacent to the acute angle side lateral edge in the tire circumferential direction. Thus, toe and heel wear at or near the ground contact end can be suppressed.

When the chamfered portion occupies less than 50% of the region defined by the width of ¼ of the shoulder ground contact width in the tire width direction, the portion at or near the ground contact end in the acute angle side lateral edge is likely to come into contact with the ground at a high ground pressure. This accelerates wear to cause insufficient suppression of the toe and heel wear.

The chamfered portion preferably has a width of 50% or less of the shoulder ground contact width in the tire width direction.

According to the present structure, the chamfered portion is not excessively formed in the tire width direction, so that an edge portion composed of the acute angle side lateral edge is secured with a predetermined length. Accordingly, an edge effect due to the acute angle side lateral edge is likely to be exerted to enable deterioration in traction performance to be suppressed. When the chamfered portion exceeds 50% of the shoulder ground contact width, the acute angle side lateral edge is shortened. Thus, the edge effect due to the acute angle side lateral edge is reduced, so that the traction performance is likely to deteriorate.

In addition, the chamfered portion preferably has a cross-sectional shape in a direction orthogonal to an extension direction of the shoulder lateral grooves, being inclined linearly from the top face of the shoulder block to a circumferential end face.

According to the present structure, the chamfered portion can be easily formed.

Besides this, the chamfered portion may be formed having a cross-sectional shape in the direction orthogonal to the extension direction of the shoulder lateral grooves in an R-curved shape or a stepped shape from the top face of the shoulder block to the circumferential end face.

In addition, the chamfered portion preferably has a cross-sectional shape in the direction orthogonal to the extension direction of the shoulder lateral grooves, having an angle with respect to a tire radial direction, the angle decreasing radially inward.

According to the present structure, the chamfered portion is easily formed so as to increase its length in the tire radial direction while being prevented from increasing in length in the tire circumferential direction. Accordingly, in an initial stage of wear of the shoulder block, ground contact is suppressed by the chamfered portion having a large angle with respect to the tire radial direction. Meanwhile, as wear progresses, the shoulder block decreases in height to increase in rigidity. Thus, the chamfered portion formed to be small in an appropriate size facilitates securing a ground contact face in the tire circumferential direction. Thus, the chamfered portion can have an appropriate size in accordance with wear of the shoulder block, so that toe and heel wear is likely to be suppressed while the ground contact face of the shoulder block is maintained.

In addition, a plurality of the chamfered portions is preferably provided in the tire width direction.

According to the present structure, the chamfered portions can be disposed in the shoulder block in a balanced manner in the tire width direction. Accordingly, the acute angle side lateral edge of the shoulder block is likely to have uniform rigidity in the tire width direction, so that increase in uneven wear in the tire width direction is suppressed.

It is preferable that the chamfered portion is an acute angle side chamfered portion, and the shoulder block is formed with an obtuse angle side chamfered portion in the obtuse angle side lateral edge of the plurality of lateral edges, having an obtuse angle with respect to the tire circumferential direction, the obtuse angle side chamfered portion being provided at a position facing the acute angle side chamfered portion in tire circumferential direction, and the obtuse angle side chamfered portion being smaller than the acute angle side chamfered portion.

According to the present structure, the obtuse angle chamfered portion is formed at a position facing the acute angle chamfered portion, so that wear in the portion at or near the ground contact end where ground contact pressure is likely to increase is suppressed in the obtuse angle side lateral edge. In addition, the obtuse angle side lateral edge has higher rigidity than the acute angle side lateral edge, so that making the obtuse angle side chamfered portion smaller in size than the acute angle side chamfered portion suppresses increase in difference in rigidity from the acute angle side lateral edge with suppressing excessive increase in the rigidity of the obtuse angle side lateral edge. Accordingly, increase in toe and heel wear caused by forming the obtuse chamfered portion is suppressed.

The chamfered portion preferably has a width of 35% of the shoulder ground contact width in the tire width direction.

The chamfered portion preferably includes a chamfered body positioned in a central portion in the tire width direction, and a pair of chamfer transition portions positioned on both sides of the chamfered body in the tire width direction, the chamfered body extending in the tire width direction with the same cross-sectional shape, and the chamfer transition portions being each inclined in a direction away from the chamfered body in the tire width direction from an end portion of the chamfered body in the tire width direction, outward in a tire radial direction.

According to the present invention, toe and heel wear in the portion at or near the ground contact end can be suppressed in the shoulder block defined by the shoulder lateral grooves inclined with respect to the tire width direction.

### BRIEF DESCRIPTION OF THE DRAWINGS

The foregoing and the other features of the present invention will become apparent from the following description and drawings of an illustrative embodiment of the invention in which:

FIG. 1 is a partial development view of a tread portion of a pneumatic tire according to an embodiment of the present invention;

FIG. 2 is a cross-sectional view taken along line II-II of FIG. 1;

FIG. 3 is a cross-sectional view taken along line III-III of FIG. 1;

FIG. 4 is an enlarged perspective view illustrating a chamfered portion;

FIG. 5A is a cross-sectional view similar to FIG. 3, illustrating a chamfered portion according to a modification;

FIG. 5B is a cross-sectional view similar to FIG. 3, illustrating a chamfered portion according to another modification;

FIG. 5C is a cross-sectional view similar to FIG. 3, illustrating a chamfered portion according to yet another modification;

FIG. 6 is a plan view illustrating the periphery of a shoulder block showing a chamfered portion according to yet another modification;

FIG. 7 is a plan view illustrating the periphery of a shoulder block showing a chamfered portion according to yet another modification; and

FIG. 8 is a cross-sectional view taken along line VIII-VIII of FIG. 7.

### DETAILED DESCRIPTION OF EMBODIMENTS

Hereinafter, an embodiment according to the present invention will be described with reference to accompanying drawings. The following description is merely intrinsically exemplary, and is not intended to limit the invention, its application, or its use. In addition, the drawings are schematic, and ratios of respective dimensions and the like are different from actual ones.

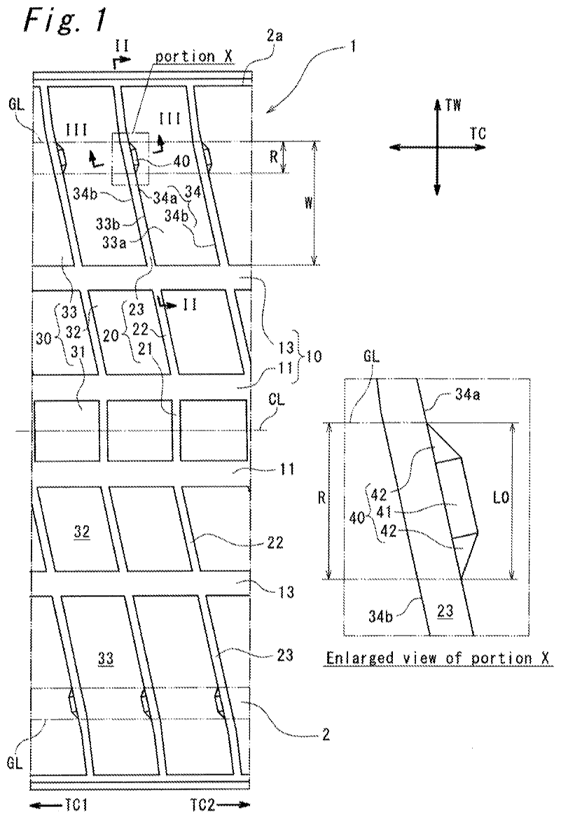

FIG. 1 is a partial development view of a tread portion 2 of a pneumatic tire 1 according to an embodiment of the present invention. As illustrated in FIG. 1, the tread portion 2 includes a plurality of main grooves 10 extending in a tire circumferential direction TC, a plurality of lateral grooves 20 extending in a tire width direction TW, and a plurality of blocks 30 defined by the corresponding main grooves 10 and lateral grooves 20. The pneumatic tire 1 according to the present embodiment is formed on both sides with a tire equator line CL interposed between the sides in a point symmetric manner, and thus one side (an upper side in FIG. 1) will be described in the following description.

The plurality of main grooves 10 includes a center main groove 11 formed in a central portion of the tread portion 2 in the tire width direction TW, and a shoulder main groove 13 formed outside the center main groove 11 in the tire width direction TW and inside a ground contact end GL in the tire width direction TW, the grooves being formed on respective sides with respect to the tire equator line CL interposed between the sides.

The ground contact end GL in the present specification means an outer end portion of a ground contact face in the tire width direction in a top face of the tread portion 2 of the pneumatic tire 1 in a new state (i.e., not worn), being mounted on a regular rim and inflated at a regular internal pressure, the ground contact face coming into contact with a flat road surface when a load of 90% of a maximum load capacity at the regular internal pressure is applied to the pneumatic tire 1.

The “regular rim” is a rim determined for each tire in the standard system including a standard to which a tire conforms, according to the standard, and refers to a “Standard Rim” defined by JATMA, a “Design Rim” defined by TRA, and a “Measuring Rim” defined by ETRTO, for example.

The “regular internal pressure” is an air pressure determined for each tire in the standard system including a standard to which a tire conforms, according to each standard, and refers to “maximum air pressure” defined by JATMA, a maximum value described in the table, “TIRE LOAD LIMITS AT VARIOUS COLD INFLATION PRESSURES”, defined by TRA, and “INFLATION PRESSURE” defined by ETRTO.

“Regular load” is a load determined for each tire in the standard system including a standard to which a tire conforms, according to each standard, and refers to “Maximum load capacity” defined by JATMA, a maximum value described in the table, “TIRE LOAD LIMITS AT VARIOUS COLD INFLATION PRESSURES”, defined by TRA, and “LOAD CAPACITY” defined by ETRTO.

The plurality of lateral grooves 20 includes a center lateral groove 21 that communicates with a pair of the center main grooves 11 in the tire width direction TW, a mediate lateral groove 22 that communicates with the center main groove 11 and the shoulder main groove 13 in the tire width direction TW, and a shoulder lateral groove 23 extending from the shoulder main groove 13 to a lateral outer end portion 2a of the tread portion 2 in the tire width direction TW beyond the ground contact end GL.

The plurality of blocks 30 includes a center block 31 defined by the center main groove 11 and the center lateral groove 21, a mediate block 32 defined by the center main groove 11, the shoulder main groove 13, and the mediate lateral groove 22, and a shoulder block 33 defined by the shoulder main groove 13 and the shoulder lateral groove 23. The shoulder block 33 includes a top face 33a constituting the ground contact face and a circumferential end face 33b extending radially inward from a circumferential end of the top face 33a.

The shoulder block 33 includes a pair of lateral edges 34 extending in the tire width direction TW on both sides of the top face 33a in the tire circumferential direction TC, the pair of lateral edges 34 each being defined by the shoulder lateral groove 23. The shoulder lateral groove 23 is here inclined with respect to the tire width direction TW. Specifically, the shoulder lateral groove 23 extends inclined toward a tire circumferential direction TC1 (left side in FIG. 1) while extending outward in the tire width direction TW. Accordingly, the pair of lateral edges 34 extend inclined toward the tire circumferential direction TC1 while extending outward in the tire width direction TW.

The pair of lateral edges 34 include an acute angle side lateral edge 34a positioned on a tire circumferential direction TC1 side, having an acute angle with respect to the tire circumferential direction TC, and an obtuse angle side lateral edge 34b positioned on a tire circumferential direction TC2 side (right side in FIG. 1), having an obtuse angle with respect to the tire circumferential direction TC.

In other words, a pair of the shoulder blocks 33 adjacent to each other in the tire circumferential direction TC include the shoulder block 33 positioned on the tire circumferential direction TC1 side, having the obtuse angle side lateral edge 34b, and the shoulder block 33 positioned on the tire circumferential direction TC2 side, having the acute angle side lateral edge 34a, the obtuse angle side lateral edge 34b and the acute angle side lateral edge 34a being positioned on respective sides in the tire circumferential direction TC with respect to the shoulder lateral groove 23 interposed between the sides while facing each other.

The acute angle side lateral edge 34a is provided in its predetermined range with a chamfered portion 40 formed in a chamfered shape extending from the top face 33a to the circumferential edge face 33b. The chamfered portion 40 does not communicate with the shoulder main groove 13 and the lateral outer end portion 2a of the tread portion 2, and terminates inside the shoulder block 33 (i.e., the acute angle side lateral edge 34a) in tire width direction TW. The chamfered portion 40 includes a chamfered body 41 positioned in its center portion in the tire width direction TW and a pair of chamfered transition portions 42 positioned on its both sides in the tire width direction TW. The chamfered portion 40 constitutes the acute angle side chamfered portion in the present invention.

The chamfered portion 40 is at least partly positioned in a region R from the ground contact end GL to inward in the tire width direction TW in the acute angle side lateral edge 34a, the region R being defined as ¼ of a shoulder ground contact width W from the shoulder main groove 13 to the ground contact end GL. Specifically, a ratio of the chamfered portion 40 with respect to the region R is set to 50% or more in the tire width direction TW.

Specifically, the chamfered portion 40 has a portion positioned in the region R, having a width L0 in the tire width direction TW, being set to 50% or more of ¼W that is a width of the region R. In the present embodiment, the chamfered portion 40 is formed corresponding to the entire region R, and the width L0 of the chamfered portion 40 is equal to ¼W that is the width of the region R. That is, the chamfered portion 40 is at least positioned at or near inside the ground contact end GL in the tire width direction TW.

The width L0 of the chamfered portion 40 and the shoulder ground contact width W each mean a length measured in a direction along a ground contact face of the tread portion 2 (i.e., the shoulder block 33). In the present embodiment, the chamfered portion 40 is formed corresponding to the region R, and the width L0 is equal to the width ¼W of the region R. The width L0 of the chamfered portion 40 is a total length of the chamfered body 41 and the chamfer transition portions 42.

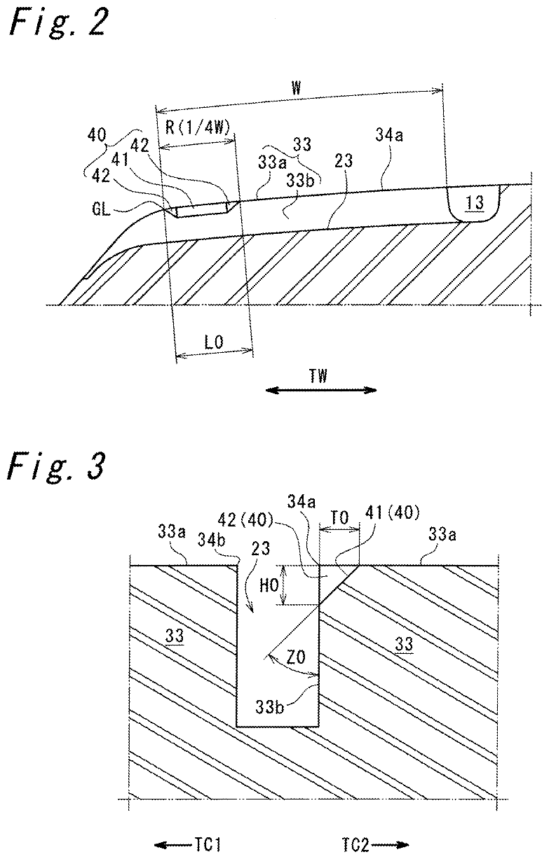

FIG. 2 is a cross-sectional view taken along the shoulder lateral groove 23, and is a front view of the chamfered portion 40 as viewed from the tire circumferential direction TC. FIG. 3 is a cross-sectional view of a portion at a position at which the chamfered body 41 is formed, taken along a direction orthogonal to an extension direction of the shoulder lateral groove 23. As illustrated in FIGS. 2 and 3, in the present embodiment, the chamfered body 41 has a cross-sectional shape that is linearly inclined inward in a tire radial direction toward the tire circumferential direction TC1 from the top face 33a to the circumferential end face 33b.

The chamfered portion 40 has the width L0 in the tire width direction, being set to 50% or less of the shoulder ground contact width W, and more preferably set to 35% or less of the shoulder ground contact width W. This suppresses excessive increase in length of the chamfered portion 40, so that an edge portion excluding the chamfered portion 40 can be secured in the acute angle side lateral edge 34a.

In the present embodiment, the chamfered body 41 has an inclination angle Z0 to the tire radial direction, being set to 45°, and a circumferential length T0 and a radial length H0, each being set to 2 mm or more and 4 mm or less. In addition, the chamfered portion 40 may be formed with an arbitrary inclination angle Z0, circumferential length T0, and radial length H0.

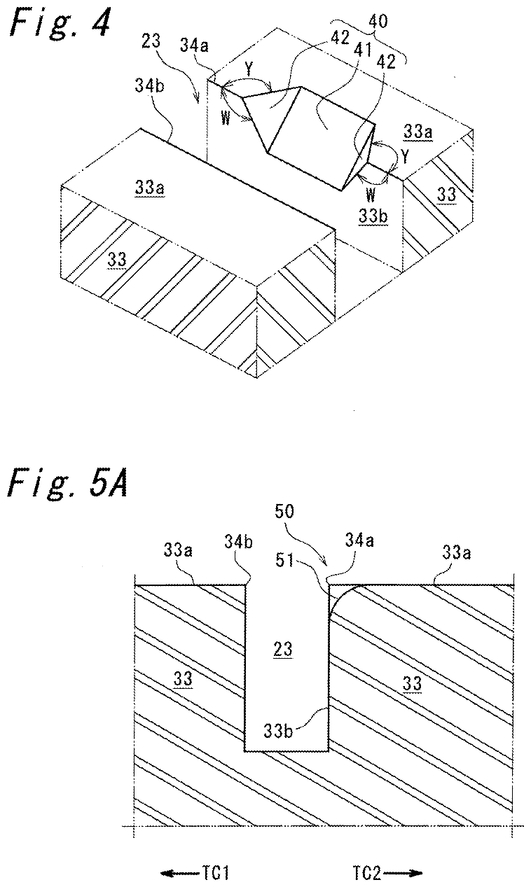

FIG. 4 is an enlarged perspective view illustrating the periphery of the chamfered portion 40. As illustrated in FIG. 4, the chamfer transition portion 42 is inclined in a direction away from the chamfered body 41 in the tire width direction TW from both ends of the chamfered body 41 in the tire width direction TW outward in the tire radial direction. Thus, the chamfer transition portion 42 is formed having angles Y and W to the top face 33a and the circumferential end face 33b, respectively, the angles Y and W each being an obtuse angle.

Accordingly, when the chamfered portion 40 is formed in a lateral edge 34 by being terminated in a middle portion of the lateral edge 34 to be prevented from extending to the shoulder main groove 13 and the lateral outer end portion 2a of the tread portion 2, both end portions of the chamfered portion 40 in the tire width direction TW are each formed in a chamfered shape inclined in the tire width direction TW. As a result, compared to the case where the chamfer transition portion 42 is not formed, deterioration in rigidity at both ends of the chamfered portion 40 is likely to be suppressed, and thus increase in wear at the both ends of the chamfered portion 40 in the tire width direction TW is likely to be suppressed.

According to the pneumatic tire 1 described above, the following effects can be obtained.

(1) The chamfered portion 40 is formed at or near the ground contact end GL where the ground contact pressure is particularly likely to increase in the acute angle side lateral edge 34a of the shoulder block 33. Forming the chamfered portion 40 causes a portion positioned at or near the ground contact end GL in the acute angle side lateral edge 34a, having relatively low rigidity, to be less likely to come into contact with the ground. As a result, wear in the portion at or near the ground contact end in the acute angle side lateral edge 34a is suppressed to cause reduction in a difference in the amount of wear between the acute angle side lateral edge 34a and the obtuse angle side lateral edge 34b in the shoulder block 33, adjacent to the acute angle side lateral edge 34a in the tire circumferential direction TC. Thus, toe and heel wear at or near the ground contact end GL can be suppressed.

When the chamfered portion 40 occupies less than 50% of the region R defined by the width of ¼ of the shoulder ground contact width W in the tire width direction TW, a portion positioned at or near the ground contact end GL in the acute angle side lateral edge 34a is likely to come into contact with the ground at a high ground pressure. This accelerates wear to cause insufficient suppression of the toe and heel wear.

(2) The chamfered portion 40 has the width L0 that is 50% or less of the shoulder ground contact width W, so that the chamfered portion 40 is not excessively formed in the tire width direction TW. Accordingly, the acute angle side lateral edge 34a is secured with a predetermined length, so that an edge effect due to the acute angle side lateral edge 34a is likely to be exerted to enable deterioration in traction performance to be suppressed. When the chamfered portion 40 exceeds 50% of the shoulder ground contact width W, the portion excluding the chamfered portion 40 of the acute angle side lateral edge 34a is shortened. Thus, the edge effect due to the acute angle side lateral edge 34a is reduced, so that the traction performance is likely to deteriorate.

(3) The chamfered body 41 is an inclined face, and thus can be easily formed.

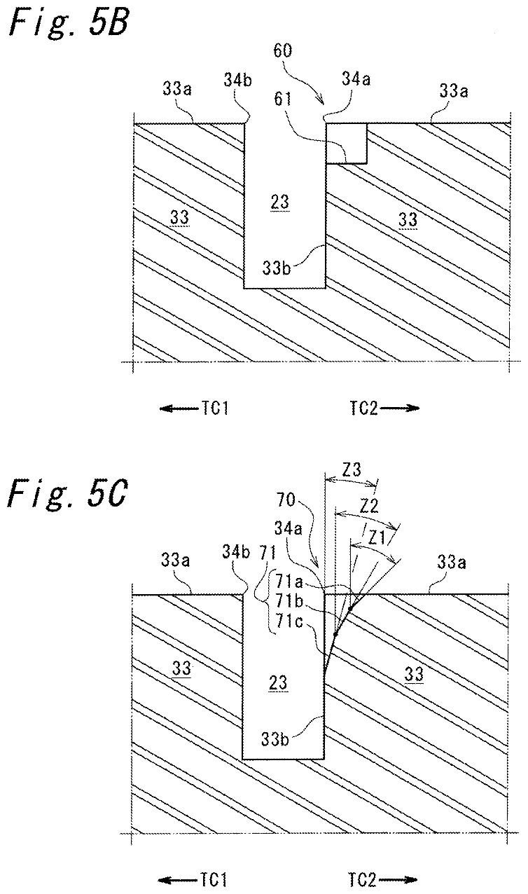

While the above embodiment is described in which the chamfered body 41 is an inclined face, for example, the present invention is not limited to this. FIGS. 5A to 5C are each a cross-sectional view similar to FIG. 3, and illustrate chamfered portions 50, 60, and 70 according to modifications, respectively. As illustrated in FIG. 5A, the chamfered portion 50 having an R-curved chamfered body 51 may be formed. As illustrated in FIG. 5B, the chamfered portion 60 having a stepped chamfered body 61 may be formed.

In addition, as illustrated in FIG. 5C, the chamfered portion 70 including a chamfered body 71 having an angle with respect to the tire radial direction, decreasing radially inward may be formed. Specifically, the chamfered body 71 may be formed having: a first inclined face 71a inclined at a first inclination angle Z1 (e.g., 45°) from the top face 33a while extending inward in the tire radial direction; a second inclined face 71b inclined at a second inclination angle Z2 (e.g., 30°) smaller than the first inclination angle Z1 from an end opposite to the top face 33a while extending inward in the tire radial direction; and a third inclined face 71c inclined at a third inclination angle Z3 (e.g., 15°) smaller than the second inclination angle Z2 from an end opposite to the top face 33a while extending inward in the tire radial direction.

The chamfered portion 70 is easily formed so as to increase its length in the tire radial direction while being suppressed from increasing in length in the tire circumferential direction TC. Accordingly, in an initial stage of wear of the shoulder block 33, ground contact is suppressed by the chamfered portion 70 (first inclined face 71a) having a large angle with respect to the tire radial direction.

Meanwhile, as wear progresses, the shoulder block 33 decreases in height to increase in rigidity. Thus, the chamfered portion 70 formed to be small in an appropriate size facilitates securing a ground contact face in the tire circumferential direction. Thus, the chamfered portion 70 can have an appropriate size in accordance with wear of the shoulder block 33, so that toe and heel wear is likely to be suppressed while the ground contact face of the shoulder block 33 is maintained.

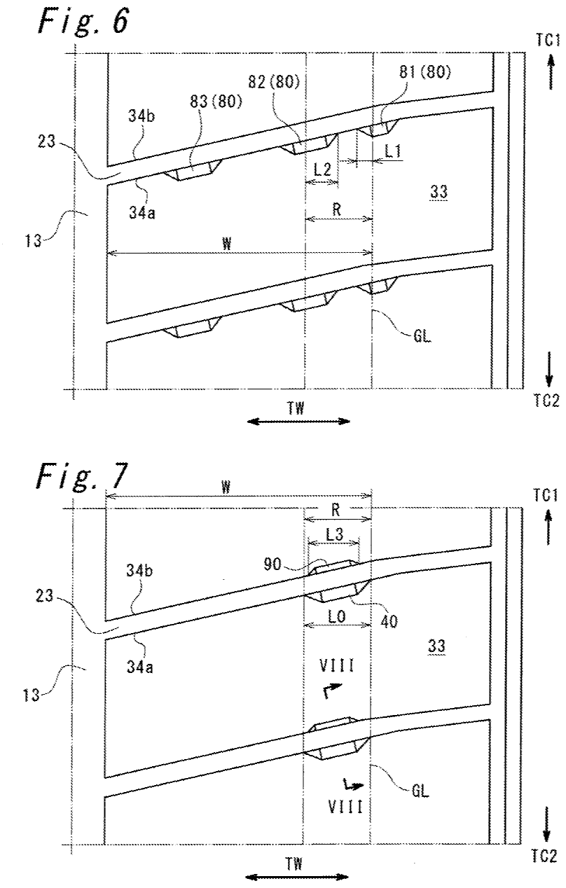

While the above embodiment is described in which only one chamfered portion 40 is formed, for example, the present invention is not limited to this. FIG. 6 is an enlarged view of the periphery of a chamfered portion 80 according to a modification, similar to FIG. 1. As illustrated in FIG. 6, a plurality of the chamfered portions 80 may be formed in the acute angle side lateral edge 34a. Even in this case, a ratio of the chamfered portions 80 in the region R that is ¼ of the shoulder ground contact width W may be 50% or more.

That is, while in the case of FIG. 6, first to third chamfered portions 81 to 83 are formed in the acute angle side lateral edge 34a, the plurality of the chamfered portions 80 only has to be formed having a total length of the first and second chamfered portions 81 and 82 positioned in the region R (a total of L1 and L2 in FIG. 6), being 50% or more of the width ¼W of region R.

When the plurality of the chamfered portions 80 is provided in the acute angle side lateral edge 34a in the tire width direction, the chamfered portions 80 can be disposed in the shoulder block 33 in a balanced manner in the tire width direction. Accordingly, the acute angle side lateral edge 34a of the shoulder block 33 is likely to have uniform rigidity in the tire width direction TW, so that increase in uneven wear in the tire width direction TW is suppressed.

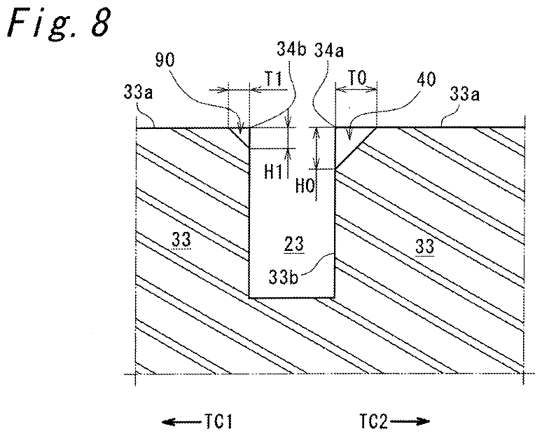

While the above embodiment is described in which the chamfered portion 40 is formed in only the acute angle side lateral edge 34a, for example, the present invention is not limited to this. FIG. 7 is an enlarged view of the periphery of a chamfered portion 90 according to a modification, similar to FIG. 1. FIG. 8 is a longitudinal sectional view of the chamfered portion 90, similar to FIG. 3. As illustrated in FIGS. 7 and 8, the chamfered portion 90 may be also formed in the obtuse angle side lateral edge 34b, at a position facing the chamfered portion 40 in the tire circumferential direction. That is, the chamfered portion 90 constitutes the obtuse angle side chamfered portion in the present invention.

In this case, the chamfered portion 90 only has to be formed to be smaller than the chamfered portion 40. For example, the chamfered portion 90 has a width L3, a circumferential length T1, and a radial length H1, all or at least one of which only have to be respectively less than the width L0, the circumferential length T0, and the radial length H0, of the chamfered portion 40.

The chamfered portion 90 is formed at a position facing the chamfered portion 40, so that wear in the portion near and at the ground contact end GL where ground contact pressure is likely to increase is suppressed in the obtuse angle side lateral edge 34b. In addition, the obtuse angle side lateral edge 34b has higher rigidity than the acute angle side lateral edge 34a, so that making the chamfered portion 90 smaller in size than the chamfered portion 40 suppresses increase in difference in rigidity from the acute angle side lateral edge 34a with excessive increase in the rigidity of the obtuse angle side lateral edge 34b. Accordingly, increase in toe and heel wear caused by forming the chamfered portion 90 in the obtuse angle side lateral edge 34b is suppressed.

In addition, the present invention is not limited to the structure described in the above embodiment, and various modifications are available.

What is claimed is:

1. A pneumatic tire comprising:
a plurality of main grooves provided in a tread portion while extending in a tire circumferential direction, including a shoulder main groove closest to a ground contact end in a tire width direction;
shoulder lateral grooves extending at least from the shoulder main groove beyond the ground contact end in a direction inclined with respect to a tire width direction; and
a shoulder block defined by the shoulder main groove and the shoulder lateral grooves,
the shoulder block having a top face provided with a plurality of lateral edges extending in the tire width direction, the plurality of lateral edges including an acute angle side lateral edge with an acute angle with respect to the tire circumferential direction, the acute angle side lateral edge being formed with a chamfered portion throughout a predetermined range in the tire width direction, and
the chamfered portion occupying an area at a ratio of 50% or more of a region from the ground contact end inward in the tire width direction, the region being defined by a width of ¼ of a shoulder ground contact width from the shoulder main groove to the ground contact end in the tire width direction.

2. The pneumatic tire according to claim 1, wherein
the chamfered portion has a width of 50% or less of the shoulder ground contact width in the tire width direction.

3. The pneumatic tire according to claim 1, wherein
the chamfered portion has a cross-sectional shape in a direction orthogonal to an extension direction of the shoulder lateral grooves, being inclined linearly from the top face of the shoulder block to a circumferential end face.

4. The pneumatic tire according to claim 1, wherein
the chamfered portion is formed having a cross-sectional shape in the direction orthogonal to the extension direction of the shoulder lateral grooves in an R-curved shape from the top face of the shoulder block to a circumferential end face.

5. The pneumatic tire according to claim 1, wherein
the chamfered portion is formed having a cross-sectional shape in the direction orthogonal to the extension direction of the shoulder lateral grooves in a stepped shape from the top face of the shoulder block to a circumferential end face.

6. The pneumatic tire according to claim 1, wherein
the chamfered portion has a cross-sectional shape in the direction orthogonal to the extension direction of the shoulder lateral grooves, having an angle with respect to a tire radial direction, the angle decreasing radially inward.

7. The pneumatic tire according to claim 1, wherein
a plurality of the chamfered portions is provided in the tire width direction.

8. The pneumatic tire according to claim 1, wherein
the chamfered portion is an acute angle side chamfered portion,
the shoulder block is formed with an obtuse angle side chamfered portion in an obtuse angle side lateral edge of the plurality of lateral edges, having an obtuse angle with respect to the tire circumferential direction, the obtuse angle side chamfered portion being provided at a position facing the acute angle side chamfered portion in tire circumferential direction, and
the obtuse angle side chamfered portion is smaller than the acute angle side chamfered portion.

9. The pneumatic tire according to claim 1, wherein
the chamfered portion has a width of 35% of the shoulder ground contact width in the tire width direction.

10. The pneumatic tire according to claim 1, wherein
the chamfered portion includes a chamfered body positioned at the center in the tire width direction, and a pair of chamfer transition portions positioned on both sides of the chamfered body in the tire width direction,
the chamfered body extends in the tire width direction with the same cross-sectional shape, and
the pair of chamfer transition portions are each inclined in a direction away from the chamfered body in the tire width direction from an end portion of the chamfered body in the tire width direction, outward in the tire radial direction.
